(19) United States
(12) Patent Application Publication
(10) Pub. No.: US 2022/0260052 A1
(43) Pub. Date: Aug. 18, 2022

(54) WIND TURBINE WITH A FLOW DEFLECTION UNIT

(71) Applicant: Kuo-Chang HUANG, Tainan City (TW)

(72) Inventor: Kuo-Chang HUANG, Tainan City (TW)

(21) Appl. No.: 17/671,987

(22) Filed: Feb. 15, 2022

(30) Foreign Application Priority Data
Feb. 17, 2021 (TW) 110105413

(51) Int. Cl. F03D 3/04; F03D 3/00; F03D 15/00; H02K 7/116; H02K 7/18

(52) U.S. Cl. CPC F03D 3/04; F03D 3/002; F05B 2220/706; H02K 7/116; H02K 7/183; F03D 15/00

(57) ABSTRACT

A wind turbine includes an axle unit having a tubular hub which is rotatably sleeved around an inner tube, a blade unit rotatable by a wind power in an operational direction and including a plurality of blades which are connected with the hub, and each of which has a wind hole formed at a root end thereof adjacent to the hub axis, and a flow deflection unit including a deflection plate which is disposed corresponding with the wind holes and connected with the inner tube. The deflection plate extends and is curved along the operational direction to collect and deflect wind flow toward the blades so as to generate a larger torque of the blades to enhance the rotating efficiency.

### CROSS-REFERENCE TO RELATED APPLICATION

This application claims priority of Taiwanese Patent Application No. 110105413, filed on Feb. 17, 2021.

### FIELD

The disclosure relates to a wind turbine, and more particularly to a wind turbine with a flow deflection unit for influencing airflow flowing to press a tip of a rotor blade.

### BACKGROUND

Referring to FIG. 1, a conventional wind turbine 1 utilizes wind forces on the windward side to rotate, and includes a rotating axle hub 11 and a plurality of blades 12 extending radially and outwardly from the rotating axle hub 11 and angularly displaced from one another to be pressed and rotated by wind. However, a wind force near the rotating axle hub 11 generates a very small torque and drive. It is desired to improve such drawback by changing the rotor blades of the wind turbine. Thus, it is considerable to reduce the structure of the blade near the rotating axle hub 11 to achieve the continuity of the momentum of the wind, and to obtain higher torsional efficiency and reduce the manufacturing costs of the blade.

### SUMMARY

Therefore, an object of the disclosure is to provide a wind turbine that can alleviate at least one of the drawbacks of the prior art.

According to the disclosure, the wind turbine includes an axle unit, at least one blade unit and at least one flow deflection unit. The axle unit has a tubular hub which is rotatable about a hub axis, and an inner tube which extends coaxially in the hub. The blade unit is rotatable by a wind power in an operational direction, and includes a plurality of blades which are connected with and extend radially and outwardly from the hub and which are angularly spaced apart from each other. Each of the blades has a wind hole formed at a root end thereof adjacent to the hub axis. The flow deflection unit includes a deflection plate which is disposed corresponding with the wind holes of the blades. The deflection plate is connected with the inner tube and extends and is curved along the operational direction. The deflection plate has a deflection surface which faces the inner tube to collect and deflect wind flow toward a corresponding one of the blades.

The blades have the wind holes formed at the root ends, and the deflection plate is disposed to deflect airflow through the wind holes toward the tip ends of the blades to generate a larger torque of the blades so as to enhance the rotating efficiency.

### BRIEF DESCRIPTION OF THE DRAWINGS

Other features and advantages of the disclosure will become apparent in the following detailed description of the embodiments with reference to the accompanying drawings, of which:

FIG. 1 is a schematic side view of a conventional wind turbine;

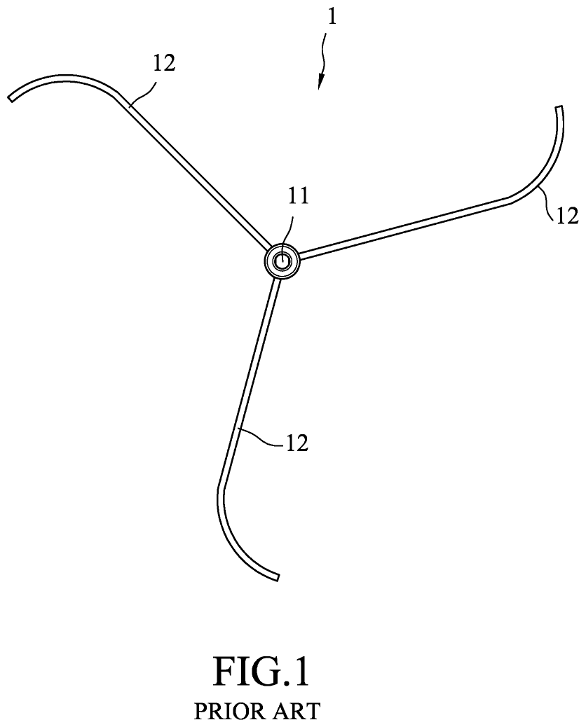

FIG. 2 is a partly-sectional front view illustrating a first embodiment of a wind turbine according to the disclosure;

FIG. 3 is a fragmentary perspective view of the first embodiment;

FIG. 4 is a side sectional view of the first embodiment;

FIG. 5 is a fragmentary perspective view illustrating a second embodiment of the wind turbine according to the disclosure;

FIG. 6 is a fragmentary, enlarged perspective view of the second embodiment;

FIG. 7 is a partly-sectional side view of the second embodiment;

FIG. 8 is a fragmentary, enlarged perspective view illustrating a third embodiment of the wind turbine according to the disclosure; and

FIG. 9 is a fragmentary, partly-sectional enlarged view of the third embodiment; and

FIG. 10 is a schematic side view illustrating a fourth embodiment of the wind turbine according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

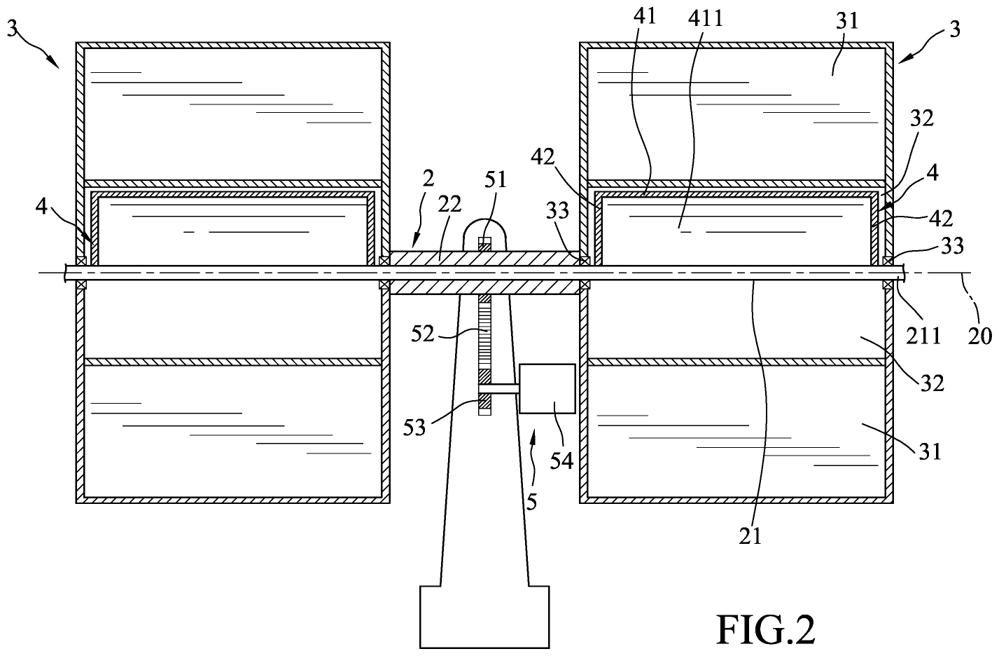

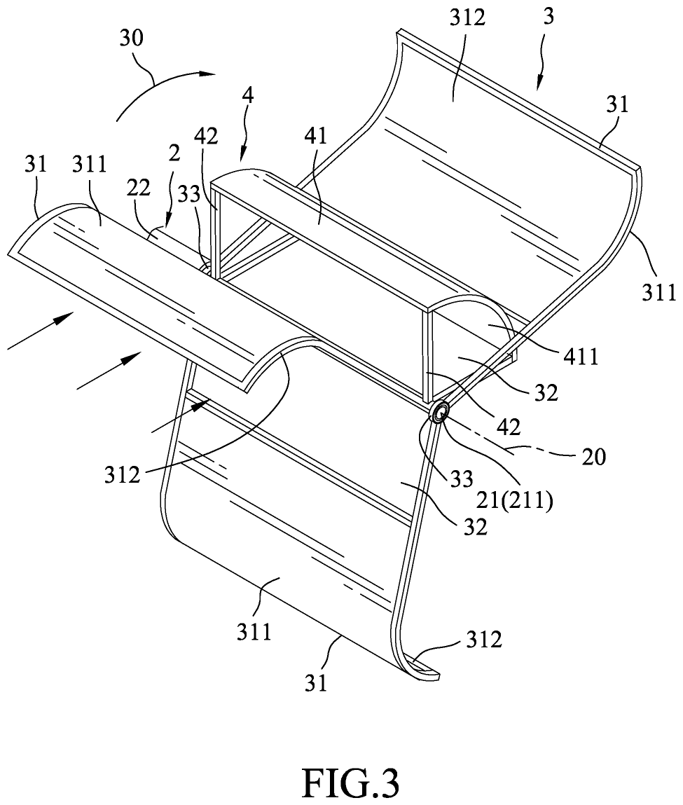

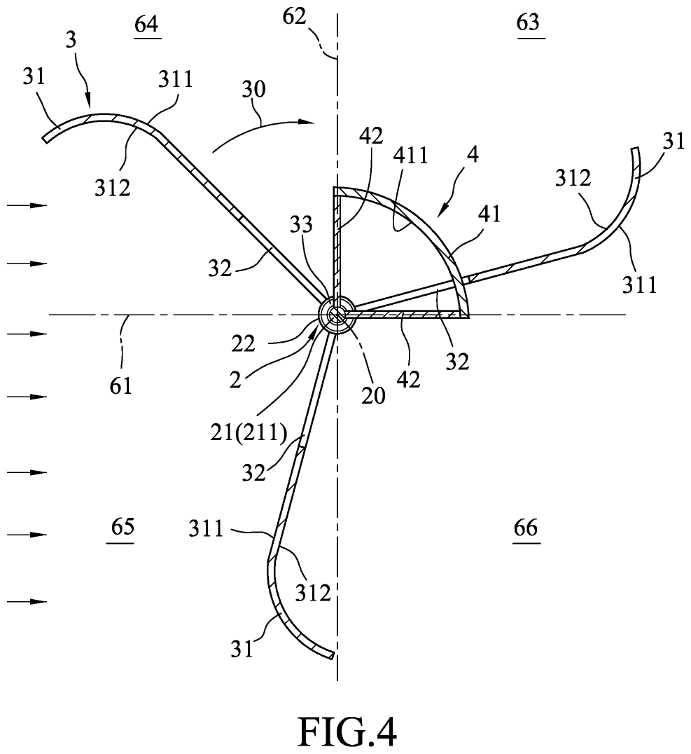

Referring to FIGS. 2, 3 and 4, a first embodiment of a wind turbine according to the disclosure includes an axle unit 2, two blade units 3, two flow deflection units 4 and an electric generating unit 5. The blade units 3 are rotatable by a wind power in an operational direction 30. The flow deflection units 4 are fixed and deflect airflow toward the blade units 3. The number of the flow deflection units 4 is the same as the number of the blade units 3, but is not limited to two. One, three or more flow deflection units 4 may be disposed according to actual needs. One blade unit 3 and a corresponding one of the flow deflection unit 4 are described as follows.

For orientation explanation, the wind turbine defines a first reference plane 61 which is parallel to a windward direction, a second reference plane 62 which is perpendicular to the first reference plane 61, and first, second, third and fourth spaces 63, 64, 65, 66 which are divided by the first reference plane 61 and the second reference plane 62 and distributed in an opposite operational direction of the blade units 3. In terms of the first reference plane 61 as a boundary, the first and second spaces 63, 64 serve as a tailwind side, and the third and fourth spaces 65, 66 serve as a headwind side. In terms of the second reference plane 62 as a boundary, the second and third spaces 64, 65 serve as a windward side, and the first and fourth spaces 63, 66 serve as a leeward side.

The axle unit 2 has a tubular hub 22 which is rotatable about a hub axis 20, and an inner tube 21 which extends coaxially in the hub 22. The hub axis 20 overlaps an intersecting line of the first reference plane 61 and the second reference plane 62. In this embodiment, the hub axis 20 is a horizontal axis, and may be a vertical axis in other various embodiments. The inner tube 21 extends through the hub 22 and has a projecting portion 211 which is disposed outwardly of the hub 22.

The blade unit 3 is disposed at an end of the hub and surrounds the projecting portion 211 of the inner tube 21. The blade unit 3 includes three blades 31 which are connected with and extend radially and outwardly from the hub 22 and which are angularly spaced apart from one another. Each of the blades 31 has a wind hole 32 formed at a root end thereof adjacent to the hub axis 20. Each blade 31 is in form of a straight linear blade, a curved blade, or a partially straight linear and partially curved blade. In this embodiment, each blade 31 has a straight plate portion proximate to the wind hole 32, and a curved plate portion curved from the straight plate portion along the opposite operational direction. The length of the wind hole 32 is about 30% to 50% of the total length of the blade 31, 40% preferably. Each of the blades 31 has a windward surface 312 and a leeward surface 311 in terms of the operational direction 30. It is noted that the number of the blades 31 is the same as the number of the wind holes 32, but is not limited to three. Two, four or more blades 31 may be disposed. The blade unit 3 further includes two bearings 33 which are connected between the blades 31 and the projecting portion 211 of the inner tube 21. The bearings 33 are spaced apart from each other along the hub axis 20. One bearing 33 is securely disposed at the end of the hub 22, and the other one bearing 33 is remote from the hub 22.

The flow deflection unit 4 is fixed to the inner tube 21 and includes a deflection plate 41 which is disposed corresponding with the wind holes 32 of the blades 31 so as to permit passing of the deflection plate 41 through the wind holes 32 during rotation of the blades 31. Specifically, the blade unit 3 surrounds the deflection plate 41 and the projecting portion 211 of the inner tube 21. The deflection plate 41 is connected with the inner tube 21 and extends and is curved along the operational direction 30. The curvature of the deflection plate 41 may be n/6, n/4, n/3 or n/2, and is n/2 in this embodiment. The deflection plate 41 is disposed in the first space 63 to deflect wind flowing from the second space 64 toward the fourth space 66. The deflection plate 41 has a deflection surface 411 which faces the inner tube 21 to collect and deflect wind flow toward a corresponding one of the blades 31. The deflection unit 4 further includes a plurality of connecting elements 42 which interconnect the deflection plate 41 and the projecting portion 211 of the inner tube 21.

The electric generating unit 5 includes a driving gear 51 which is coupled with and driven by the hub 22, a transmitting gear 52 which meshes with the driving gear 51, a driven gear 53 which meshes with the transmitting gear 52, and a generator 54 which is coupled with the driven gear 53 so as to convert rotational energy from the hub 21 into electrical energy. The transmission of the electric generating unit 5 may be a chain or a belt, instead of the transmitting gear 52.

When wind blows to the second space 64 and the third space 65, the airflow near the peripheral area of the wind turbine flows to the windward surfaces 312 of the blades 31 and drives the blades 31 to rotate in the operational direction 30. The airflow near the central area of the wind turbine flows through the wind holes 32 and meets the deflection plate 41 such that the deflection surface 411 collects and deflects the airflow toward the fourth space 66 and toward the tip end of the blade 31. As such, a wind resistance applying to the leeward surfaces 311 of the blades 31 in the third space 65 can be reduced, and the torque to drive rotation of the blades 31 in the operational direction 30 can be increased so as to enhance the rotational efficiency. The blades 31 synchronously rotate the hub 22 to transmit the torque to the electric generating unit 5 for generating electricity.

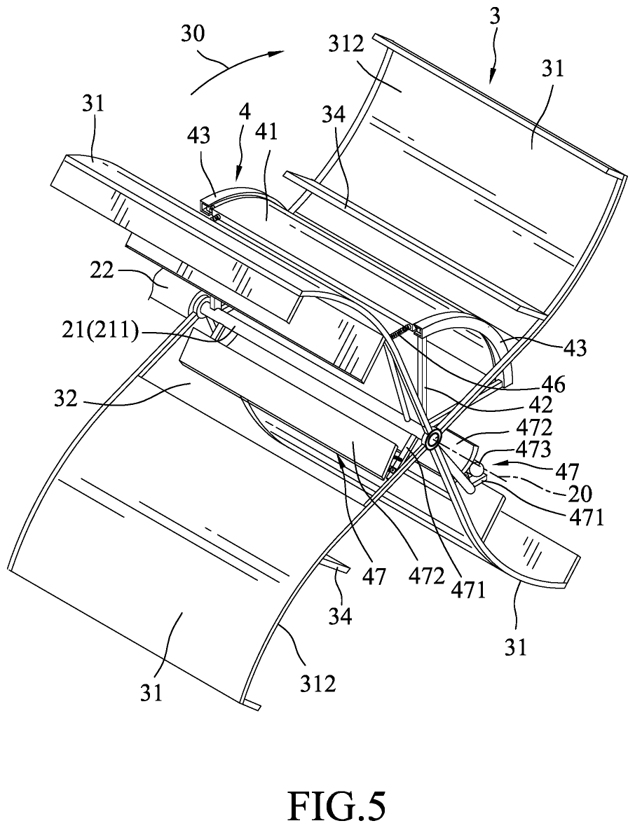

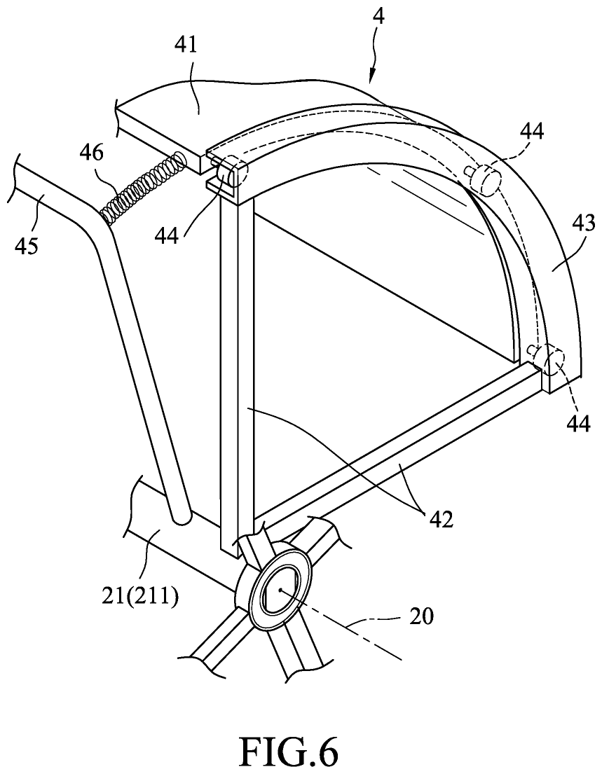

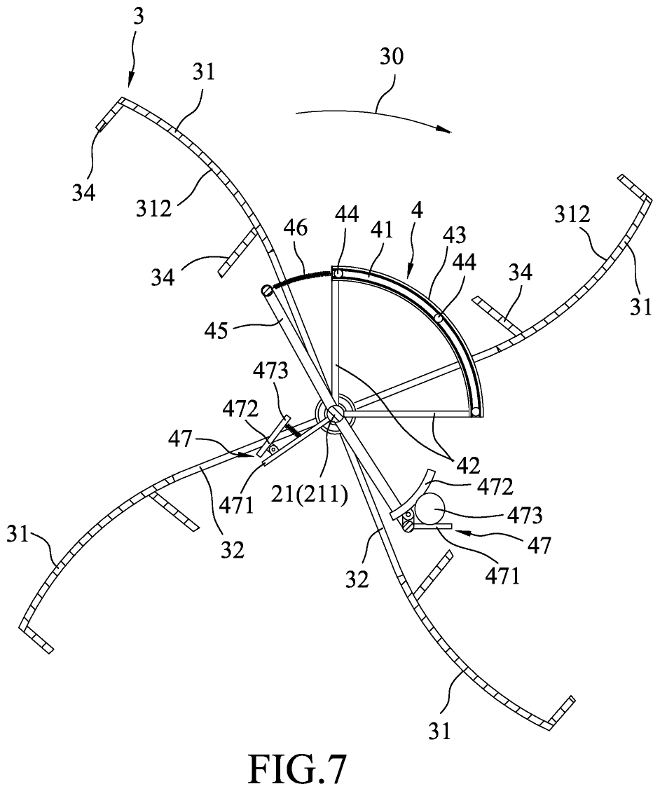

With reference to FIGS. 5, 6 and 7, in a second embodiment, four of the blades 31 are disposed in the blade unit 3. The blade unit 3 further includes a plurality of wind capturing plates 34 which project from the windward surfaces 312 of the blades 31 in a direction opposite to the operational direction 30 of the blade unit 3. With the capturing plates 34, more airflow is captured by the blade unit 3 and stays for a prolonged time to reduce loss of airflow from the blades 31 and increase the driving force.

Moreover, the flow deflection unit 4 further includes two frame rails 43 which are mounted adjacent to two sides of the deflection plate 41 and connected with the projecting portion 211 of the inner tube 21 by the connecting elements 42, a plurality of rollers 44 which are mounted on the two sides of the deflection plate 41 and slidable within and along the frame rails 43, a mounting frame 45 which is connected with the projecting portion 211 of the inner tube 21 and disposed adjacent to ends of the frame rails 43, and two biasing elements 46 each of which is connected between the mounting frame 45 and the deflection plate 41 to permit the deflection plate 41 to be movable along the frame rails 43. When subjected to a wind with a high wind speed or wind level, such as a typhoon, the deflector 41 is slidable back and forth along the frame rails 43 in a buffered manner so as to prevent the deflection plate 41 from being bent or deformed due to an excessive wind pressure. The number of the biasing elements 46 is not limited to two, and may be one, three or more in other various embodiments.

The flow deflection unit 4 further includes two auxiliary deflection modules 47 which are spaced apart from each other along the operational direction 30 and which are respectively disposed at an entrance and an exit of the deflection plate 41. Each of the auxiliary deflection modules 47 has a support element 471 which is connected with the projecting portion 211 of the inner tube 21, an auxiliary plate 472 which is pivotally connected with the support element 471 and which extends toward the deflection plate 41, and a biasing body 473, such as a biasing spring, a rubber block, a balloon, etc., which is connected between the support element 471 and the auxiliary plate 472 such that the auxiliary plate 472 movably conducts and diverts airflow through the deflection plate 41. Specifically, the auxiliary plate 472 at the entrance of the deflection plate 41 conducts and deflects a part of airflow to the deflection plate 41, and the auxiliary plate 472 at the exit of the deflection plate 41 diverts a large part of the airflow toward the tip end of the blades 31 and a small part of the airflow through the wind holes 32 so as to increase the driving force and reduce a negative pressure.

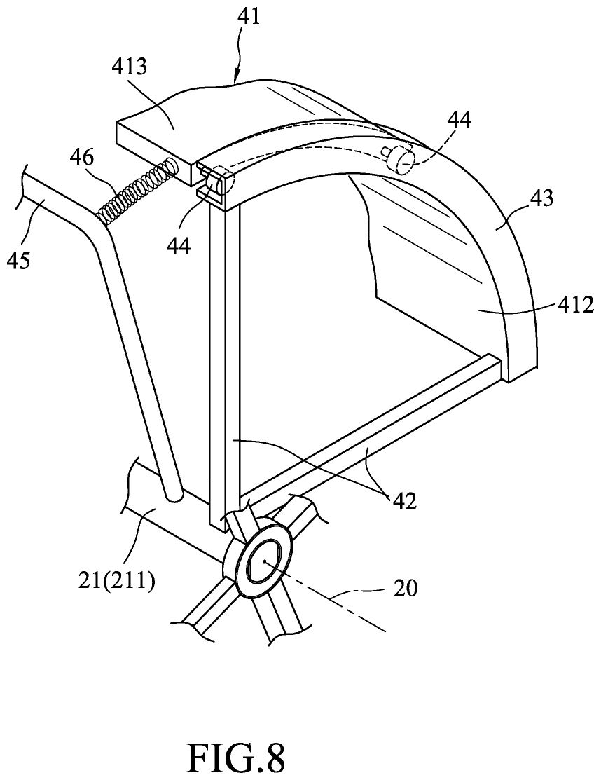

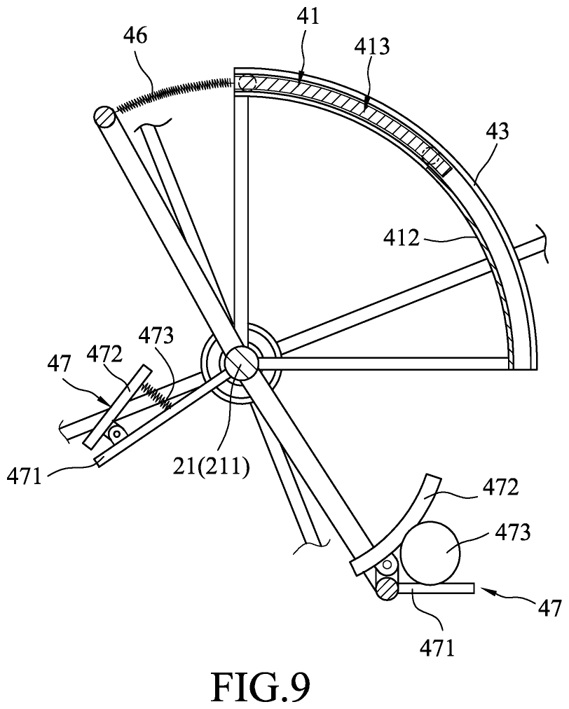

With reference to FIGS. 8 and 9, in a third embodiment, the deflection plate 41 includes a first plate half 412 and a second plate half 413 which is disposed parallel to the first plate half 412 and which is connected with the biasing element 46 such that the second plate half 413 is movable relative to the first plate half 412 between an extending position, where the second plate half 413 extends from the first plate half 412, and a superimposed position, where the second plate half 413 is superimposed upon the first plate half 412. When subjected to a wind with a high wind speed or wind level, the second plate half 413 is slidable back and forth along the frame rails 43 in a buffered manner so as to prevent the deflection plate 41 from being bent or deformed due to an excessive wind pressure.

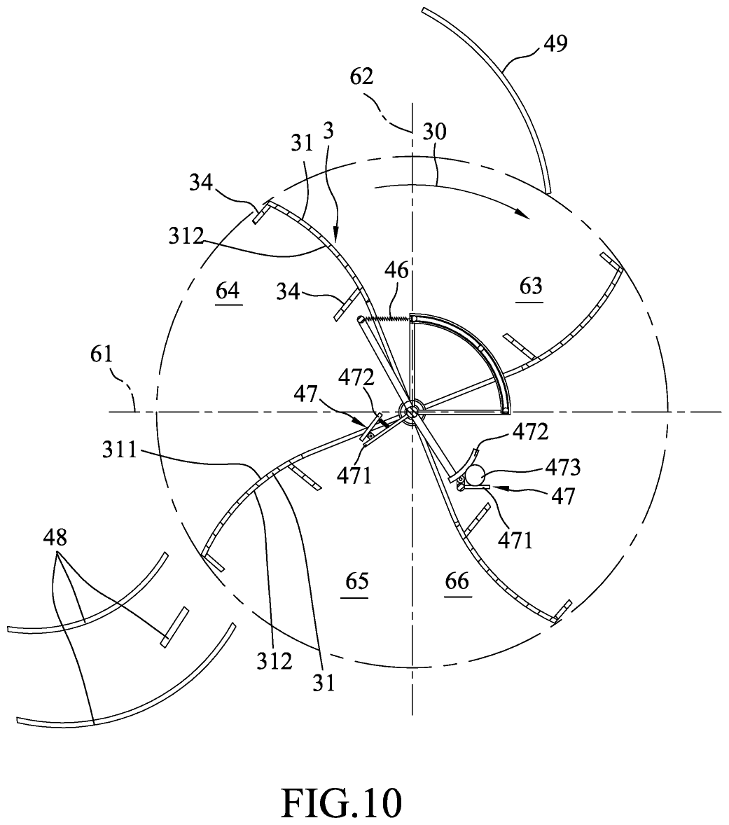

With reference to FIG. 10, in a fourth embodiment, the flow deflection unit 4 further includes three headwind plates 48 disposed outwardly of a blade rotating area of the blade unit 3 and in the third space 65, and a tailwind plate 49 disposed outwardly of a blade rotating area of the blade unit 3 and in the first space 63. The headwind plates 48 extend toward the blade unit 3 to deflect airflow in the third space 65 toward the blades 31 to prompt rotation of the blades 31 in the operational direction. Specifically, the headwind plates 48 can block the flow force of airflow flowing towards the leeward surfaces 311 of the blades 31, and can increase the pressing force to drive rotation of the blades 31 in the operational direction 30. The tailwind plate 49 extends toward the blade unit 3 to deflect airflow in the first space 63 toward the windward surfaces 312 of the blades 31 to prompt rotation of the blades 31 in the operational direction 30. The number of the headwind plates 48 is not limited to three, and the number of the tailwind plate 49 is not limited to one. One, two or more headwind plate(s) 48 and two or more tailwind plates 49 may be disposed.

As illustrated, the blades 31 have the wind holes 32 formed at the root ends, and the deflection plate 41 is disposed to deflect airflow through the wind holes 32 toward the tip ends of the blades 31 to generate a larger torque of the blades 31 so as to enhance the rotating efficiency. Moreover, with the wind holes 32, the manufacturing costs and weights of the blades 31 can be reduced.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A wind turbine comprising:
an axle unit having a tubular hub which is rotatable about a hub axis, and an inner tube which extends coaxially in said hub;
at least one blade unit rotatable by a wind power in an operational direction, and including a plurality of blades which are connected with and extend radially and outwardly from said hub and which are angularly spaced apart from each other, each of said blades having a wind hole formed at a root end thereof adjacent to the hub axis; and
at least one flow deflection unit including a deflection plate which is disposed corresponding with said wind holes of said blades, said deflection plate being connected with said inner tube and extending and being curved along the operational direction, said deflection plate having a deflection surface which faces said inner tube to collect and deflect wind flow toward a corresponding one of said blades.

2. The wind turbine as claimed in claim 1, wherein said wind turbine defines a first reference plane which is parallel to a windward direction, a second reference plane which is perpendicular to the first reference plane, and first, second, third and fourth spaces which are divided by the first reference plane and the second reference plane and distributed in an opposite operational direction of said blade unit, wherein, in terms of the second reference plane as a boundary, said second and third spaces serve as a windward side, and said first and fourth spaces serve as a leeward side, an intersecting line of the first reference plane and the second reference plane overlapping the hub axis, said deflection plate being disposed in said first space to deflect wind flowing from said second space toward said fourth space.

3. The wind turbine as claimed in claim 1, wherein said blade unit is disposed at an end of said hub, said inner tube extending through said hub and having a projecting portion which is disposed outwardly of said hub, said blade unit surrounding said deflection plate and said projecting portion, and further including two bearings which are spaced apart from each other along the hub axis and connected between said projecting portion and said blades, one of said bearings being securely disposed at said end of said hub, said deflection unit further including a plurality of connecting elements which interconnect said deflection plate and said projecting portion of said inner tube.

4. The wind turbine as claimed in claim 1, wherein said flow deflection unit further includes two frame rails which are mounted adjacent to two sides of said deflection plate and connected with said inner tube, a plurality of connecting elements which interconnect said frame rails and said inner tube, a plurality of rollers which are mounted on said two sides of said deflection plate and slidable within and along said frame rails, a mounting frame which is connected with said inner tube and disposed adjacent to ends of said frame rails, and at least one biasing element which is connected between said mounting frame and said deflection plate to permit said deflection plate to be movable along said frame rails.

5. The wind turbine as claimed in claim 4, wherein said deflection plate includes a first plate half and a second plate half which is disposed parallel to said first plate half and which is connected with said biasing element such that said second plate half is movable relative to said first plate half between an extending position, where said second plate half extends from said first plate half, and a superimposed position, where said second plate half is superimposed upon said first plate half.

6. The wind turbine as claimed in claim 1, wherein said flow deflection unit further includes two auxiliary deflection modules which are spaced apart from each other along the operational direction and which are respectively disposed at an entrance and an exit of said deflection plate, each of said auxiliary deflection modules has a support element which is connected with said inner tube, an auxiliary plate which is pivotally connected with said support element and which extends toward said deflection plate, and a biasing body which is connected between said support element and said auxiliary plate such that said auxiliary plate movably conducts and diverts airflow through said deflection plate.

7. The wind turbine as claimed in claim 1, wherein each of said blades is in form of a straight linear blade, a curved blade, or a partially straight linear and partially curved blade, and has a windward surface and a leeward surface in terms of the operational direction, said blade unit further includes a plurality of wind capturing plates which project from said windward surfaces of said blades in an opposite operational direction of said blade unit.

8. The wind turbine as claimed in claim 2, wherein said flow deflection unit further includes at least one headwind plate disposed outwardly of a blade rotating area of said blade unit and in said third space, said at least one headwind plate extending toward said blade unit to deflect airflow in said third space toward said blades to prompt rotation of said blades in the operational direction.

9. The wind turbine as claimed in claim 2, wherein said flow deflection unit further includes at least one tailwind plate disposed outwardly of a blade rotating area of said blade unit and in said first space, said at least one tailwind plate extending toward said blade unit to deflect airflow in said first space toward said blades to prompt rotation of said blades in the operational direction.

10. The wind turbine as claimed in claim 1, further comprising an electric generating unit which includes a driving gear coupled with said hub, a transmitting gear meshing with said driving gear, a driven gear meshing with said transmitting gear, and a generator coupled with said driven gear so as to convert rotational energy from said hub into electrical energy.
